(19) United States
(12) Patent Application Publication
(10) Pub. No.: US 2025/0091562 A1
(43) Pub. Date: Mar. 20, 2025

(54) DRIVE UNIT FOR AN ELECTROMECHANICAL BRAKE, ELECTROMECHANICAL BRAKE, AND VEHICLE BRAKE SYSTEM

(71) Applicant: Robert Bosch GmbH, Stuttgart (DE)

(72) Inventors: Andreas Baecker, Bretzfeld (DE); Bernd Lutz, Kempten (DE); Dietmar Kratzer, Tamm (DE); Javier Bores, Vaihingen-Kleinglattbach (DE); Kornelius Loew, Schwaigern (DE); Martin Winkler, Sonthofen (DE); Mitja Buhmann-Braun, Rettigheim (DE); Szymon Chmielewski, Abstatt (DE); Toni Eger, Weil Der Stadt (DE); Yakup Navruz, Heilbronn (DE); Andrej Gardt, Abstatt (DE)

(21) Appl. No.: 18/801,897

(22) Filed: Aug. 13, 2024

(30) Foreign Application Priority Data
Sep. 18, 2023 (DE) 10 2023 209 024.4

(51) Int. Cl. B60T 13/74

(52) U.S. Cl. CPC B60T 13/741; B60T 2270/84

(57) ABSTRACT

A drive unit for an electromechanical brake. The drive unit includes an electric motor, a transmission, and a control unit. The control unit includes a circuit board and a housing, and the transmission includes a housing cover. The housing and the housing cover surround the motor and the circuit board, and at least partially form a housing.

### CROSS REFERENCE

The present application claims the benefit under 35 U.S.C. § 119 of German Patent Application No. DE 10 2023 209 024.4 filed on Sep. 18, 2023, which is expressly incorporated herein by reference in its entirety.

### FIELD

The present invention relates to a drive unit for an electromechanical brake, to an electromechanical brake, and to a vehicle brake system comprising at least one such electromechanical brake.

### BACKGROUND INFORMATION

Usually, the service brake is a brake that uses brake fluid to press a brake piston together with a brake pad onto a brake disk in order to brake the vehicle. The parking brake, on the other hand, is designed as an electromechanical brake. In the course of the increasing electrification of units in the motor vehicle, the service brake is also to be designed as an electromechanical brake so that brake fluid and the associated complex valve and line structure can be dispensed with. The maintenance effort could also be significantly reduced by such an electromechanical brake.

European Patent No. EP 0 944 781 B1 describes an electromechanically actuatable brake, which presses a brake pad to a brake disk in order to brake.

### SUMMARY

According to an example embodiment of the present invention, a drive unit for an electromechanical brake includes an electric motor, a transmission and a control unit, the control unit includes a circuit board and a housing, and the transmission includes a housing cover, wherein the housing and the housing cover surround the motor and the circuit board and at least partially form a housing.

The background of the present invention is that the drive unit can be designed to be compact. Inside the housing, the motor is directly connectable to the control unit.

Advantageously, when the drive unit is mounted, a motor open on one side is insertable into the housing from one side and simultaneously closable with the housing of the control unit.

Further advantageous embodiments of the present invention are disclosed herein.

According to an advantageous embodiment of the present invention, the motor comprises a rotor, a motor housing, a first bearing and a second bearing, wherein the rotor is mounted by means of the first bearing and the second bearing, wherein, in particular, the first bearing is received in the housing cover and the second bearing is received in the motor housing. It is advantageous that the number of bearings is reducible.

Furthermore, according to an example embodiment of the present invention, it is advantageous if the motor comprises a rotation sensor arranged between the motor housing and the housing. The rotation sensor is thus arranged outside the motor housing and inside the housing. As a result, the rotation sensor is directly connectable to the control unit.

Advantageously, according to an example embodiment of the present invention, a wall element is arranged between the circuit board and the motor. By means of the wall element, the circuit board is electrically and/or electromagnetically isolatable and/or hermetically closable. The circuit board is thus protected from interference currents and contaminations.

It is advantageous if the wall element comprises feedthroughs for phase lines and/or a ground connection of the motor. The circuit board is thus contactable and connectable to the motor.

According to a further advantageous embodiment of the present invention, the housing cover is designed in one piece with the housing part, wherein, in particular, a further sealing means is arranged between the housing part and the wall element. It is advantageous that the motor and the circuit board are mountable from a single side of the drive unit. Thus, the drive unit does not have to be rotated during assembly.

According to an alternative advantageous embodiment of the present invention, the wall element is designed in one piece with the housing part. As a result, the circuit board and the motor are safely spaced apart from one another.

According to a further advantageous embodiment of the present invention, the control unit comprises a parking brake control element, which is arranged inside the housing, wherein, in particular, the control element is arranged adjacent to the motor and the housing cover. The drive unit can thus be designed to be compact. Advantageously, the control element is arranged spaced apart from the rotation sensor.

According to an example embodiment of the present invention, it is furthermore advantageous if the housing comprises a housing part and a cover part, wherein a second sealing element is arranged between the housing part and the cover part. The housing is thus hermetically closable.

According to an example embodiment of the present invention, it is advantageous if the circuit board is arranged between the wall element and the cover part. When assembling the drive unit, the circuit board is thus mountable from an opening of the housing part that faces the cover part, before the cover part is connected to the housing part. Advantageously, the motor and the circuit board are mountable from two opposite sides of the housing.

According to an example embodiment of the present invention, it is advantageous if a first sealing element is arranged between the housing, in particular the housing part, and the housing cover. The housing is thus hermetically closable.

According to the present invention, the electromechanical brake comprises a drive unit for an electromechanical brake, in particular as described above or disclosed herein.

The background of the present invention is that the electromechanical brake can be designed to be compact.

According to an example embodiment of the present invention, a vehicle brake system includes at least one electromechanical brake as described above or disclosed herein relating to the electromechanical brake.

The background of the present invention is that the vehicle brake system can be designed to be compact. Each electromechanical brake is controllable individually.

Advantageously, according to an example embodiment of the present invention, the vehicle brake system comprises two electromechanical brakes per vehicle axle, wherein, in particular, each wheel of a vehicle has an electromechanical brake.

The above embodiments and developments of the present invention may be combined with one another in any sensible manner. Further possible embodiments, developments and implementations of the present invention also include not explicitly mentioned combinations of features of the present invention described above or below with respect to the exemplary embodiments. A person skilled in the art will in particular also add individual aspects as improvements or additions to the particular basic form of the present invention.

### BRIEF DESCRIPTION OF THE DRAWINGS

In the following section, the present invention is explained on the basis of exemplary embodiments, which can result in further inventive features, to which the scope of the present invention is however not limited. Exemplary embodiments of the present invention are illustrated in the figures.

FIG. 1 shows an exploded view of a drive unit 100 for an electromechanical brake according to an exemplary embodiment of the present invention in an oblique view.

FIG. 2 shows an exploded side view of the drive unit 100.

FIG. 3 shows a sectional view of the drive unit 100.

### DETAILED DESCRIPTION OF EXAMPLE EMBODIMENTS

In the figures, identical reference signs denote identical or functionally identical elements.

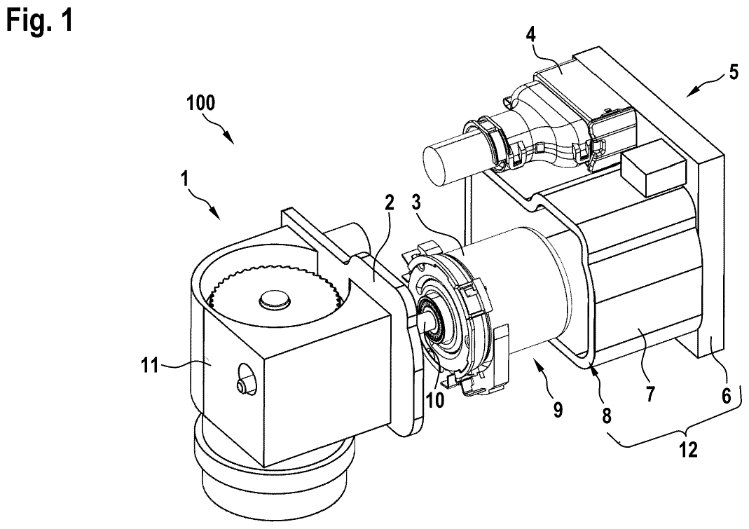

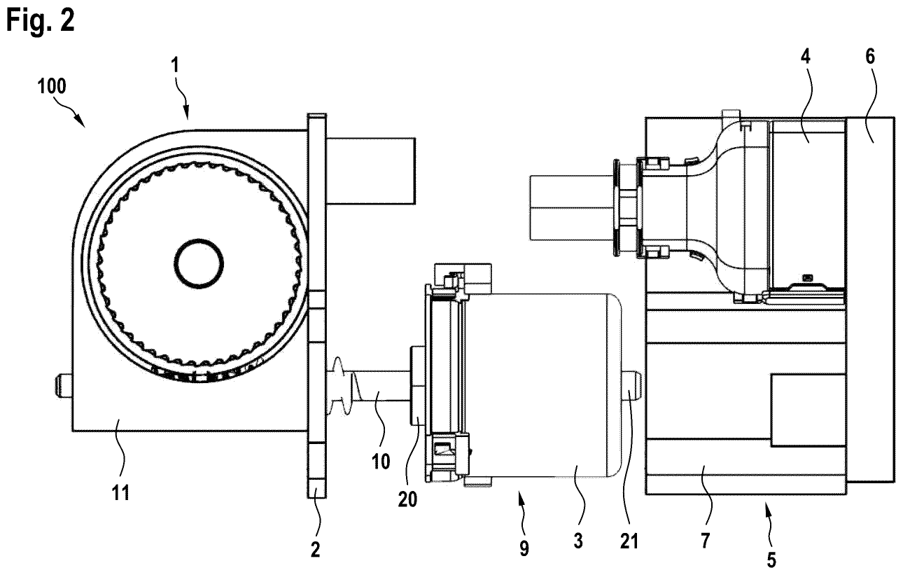

The drive unit 100 shown in FIGS. 1 and 2 for an electromechanical brake comprises a transmission 1, an electric motor 9 and a control unit 5. The control unit 5 controls the motor 9, which drives the transmission 1.

The transmission 1 comprises a transmission housing 11 with a housing cover 2, a drive shaft 10, and an output shaft. The drive shaft 10 is connected to a rotor of the motor 9 in a rotationally fixed manner. The drive shaft 10 may be designed as a pinion shaft.

The output shaft of the transmission 1 is connected to a spindle drive arrangement not shown in the figures, which in turn is connected to a brake piston that is displaceable between a braking position and a rest position.

The control unit 5 comprises a housing 12, comprising a housing part 7 and a cover part 6, as well as a plug connector connection part 4. The housing part 7 comprises a first sealing surface 8, by means of which the transmission housing 11 is connectable to the housing cover 2. The housing part 7 comprises a second sealing surface, by means of which the transmission housing 11 is connectable to the cover part 6. The cover part 6 is arranged opposite to the housing cover 2, and the housing part 7 is arranged between the cover part 6 and the housing cover 2. The plug connector connection part 4 is arranged on the cover part 6, in particular adjacent to the housing part 7. The plug connector connection part 4 extends in the same direction as the housing part 7.

The motor 9 comprises a motor housing 3. The motor 9 is arranged inside the housing 12 of the control unit 5. The motor 9 is surrounded by the cover part 6, the housing part 7, and the housing cover 2, which at least partially form a housing. The drive shaft 10 extends from the transmission 1 through a recess in the housing cover 2 to the motor 9.

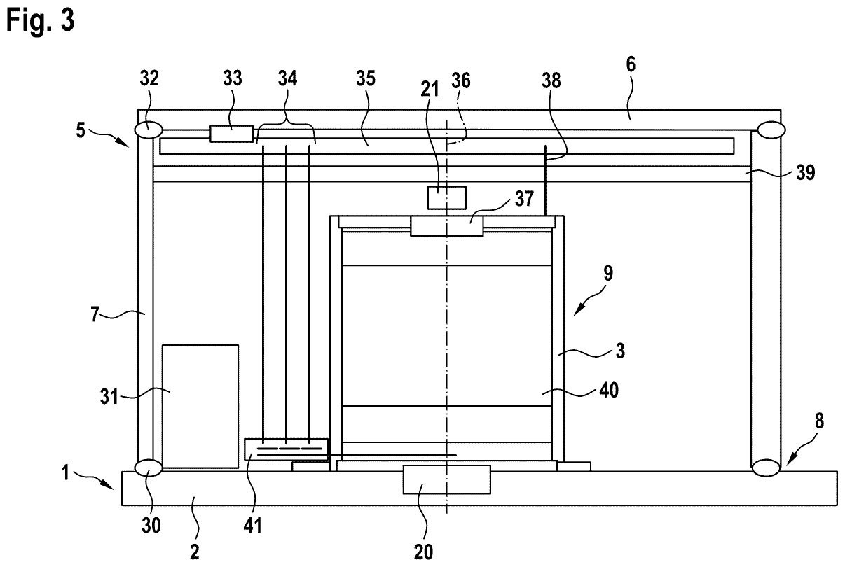

In FIG. 3, further details of the drive unit 100 are shown in a sectional view. A cut surface through an axis of rotation 36 of the motor 9 is shown.

The motor 9 comprises a rotor, which is mounted by means of a first bearing 20 and a second bearing 37. On an outside of the motor housing 3, a rotation sensor 21 or rotary encoder for determining a rotor position is arranged opposite to the second bearing 37. The first bearing 20 extends at least partially into the housing cover 2. Preferably, the first bearing 20 is received in the housing cover 2 so that a first end of the rotor is mounted in the housing cover 2 by means of the first bearing 20 and a second end of the rotor is mounted in the motor housing 3 by means of the second bearing 37.

The rotor and the stator 40 of the motor 9 are arranged inside the motor housing 3.

The control unit 5 comprises a circuit board 35, which is arranged in the housing 12. A wall element 39, which is connected to the housing part 7, is arranged between the circuit board 35 and the motor 9, wherein, in particular, the wall element 39 and the housing part 7 are designed in one piece. The circuit board 35 is arranged between the wall element 39 and the cover part 6 so that the circuit board 35 is surrounded by the housing part 7, the cover part 6, and the wall element 39, which form a housing.

The stator 40 comprises windings 40 that are electrically conductively connected to the circuit board 35. For this purpose, the motor 9 comprises a connection element 41, which is connected to the circuit board 35 by means of three phase conductors 34. Preferably, the phase conductors 34 each comprise a flat plug, which is received in a respective socket of the connection element 41.

The phase conductors 34 and a ground connection 38 of the circuit board 35, which ground connection is electrically conductively connected to the motor housing 3, are passed through the wall element 39 by means of feedthroughs.

The circuit board 35 is connected to the plug connector connection part 4 by means of a bridge element 33. The bridge element 33 is designed as a three-phase bridge. The bridge element 33 is arranged between the circuit board 35 and the cover part 6.

The control unit 5 comprises a parking brake control element 31. The control element 31 is arranged inside the housing 12 and adjacent to the motor 9 and the housing cover 2. The control element 31 is thus arranged spaced apart from the second bearing 37.

A first sealing means 30 is arranged between the cover part 6 and the housing part 7. A second sealing means 32 is arranged between the housing cover 2 and the housing part 7.

According to an alternative embodiment not shown in the figures, the housing part 7 is designed in one piece with the housing cover 2. In this case, the wall element 39 is designed to be separate, and a further sealing means is arranged between the wall element 39 and the housing part 7. For assembly, the housing part 7 and the housing cover 2 are connected to the transmission housing 11, the motor 9 is subsequently connected to the transmission 1. The wall element 39 is then inserted and sealed to the housing part 7 by means of the further sealing means. Thereafter, the circuit board 35 is mounted and connected. Finally, the housing part 7 is closed with the cover part 6, wherein the second sealing means 32 is arranged between the cover part 6 and the housing part 7.

What is claimed is:

1. A drive unit for an electromechanical brake, comprising:
an electric motor;
a transmission; and
a control unit;
wherein the control unit includes a circuit board and a housing, and the transmission includes a housing cover, and wherein the housing of the control unit and the housing cover of the transmission surround the motor and the circuit board, and at least partially form a housing of the drive unit.

2. The drive unit according to claim 1, wherein the motor includes a rotor, a motor housing, a first bearing, and a second bearing, wherein the rotor is mounted using the first bearing and the second bearing, wherein the first bearing is received in the housing cover and the second bearing is received in the motor housing.

3. The drive unit according to claim 2, wherein the motor includes a rotation sensor arranged between the motor housing and the housing of the control unit.

4. The drive unit according to claim 1, wherein a wall element is arranged between the circuit board and the motor, wherein the wall element includes feedthroughs for phase lines and/or a ground connection of the motor.

5. The drive unit according to claim 4, wherein the housing of the control unit includes a housing part and a cover part, wherein, a second sealing element is arranged between the housing part and the cover part.

6. The drive unit according to claim 5, wherein the housing cover of the transmission is configured in one piece with the housing part, wherein, a further sealing arrangement is arranged between the housing part and the wall element.

7. The drive unit according to claim 5, wherein the wall element is configured in one piece with the housing part.

8. The drive unit according to claim 1, wherein a first sealing element is arranged between the housing part and the housing cover.

9. The drive unit according to claim 1, wherein the control unit includes a parking brake control element, wherein the control element is arranged inside the housing of the control unit, and wherein the control element is arranged adjacent to the motor and the housing cover.

10. An electromechanical brake, comprising:
a drive unit including:
an electric motor,
a transmission, and
a control unit,
wherein the control unit includes a circuit board and a housing, and the transmission includes a housing cover, and wherein the housing of the control unit and the housing cover of the transmission surround the motor and the circuit board, and at least partially form a housing of the drive unit.

11. A vehicle brake system, comprising:
at least one electromechanical brake including:
an electromechanical brake, including:
a drive unit including:
an electric motor,
a transmission, and
a control unit,
wherein the control unit includes a circuit board and a housing, and the transmission includes a housing cover, and wherein the housing of the control unit and the housing cover of the transmission surround the motor and the circuit board, and at least partially form a housing of the drive unit.
